(19) United States
(12) Patent Application Publication
(10) Pub. No.: US 2023/0021374 A1
(43) Pub. Date: Jan. 26, 2023

(54) SYSTEM AND METHOD FOR ADDITIVE METAL CASTING

(71) Applicant: Magnus Metal Ltd., Tzora (IL)

(72) Inventors: Gil LAVI, Ness Ziona (IL); Boaz VINOGRADOV, Rehovot (IL); Shimon SANDIK, Petach Tikva (IL); Natalie LEVINSOHN, Mazkeret Batya (IL); Ido HOLCMAN, Rehovot (IL); Oren GARTZMAN, Shoham (IL); Emil WEISZ, Modi'in-Maccabim-Reut (IL)

(21) Appl. No.: 17/744,686

(22) Filed: May 15, 2022

Related U.S. Application Data
(60) Provisional application No. 63/224,658, filed on Jul. 22, 2021.
(60) Provisional application No. 63/283,980, filed on Nov. 29, 2021.

(51) Int. Cl. B22D 23/00; C21D 1/26; B33Y 10/00; B33Y 40/20; B33Y 30/00

(52) U.S. Cl. CPC B22D 23/003; C21D 1/26; B33Y 10/00; B33Y 40/20; B33Y 30/00

(57) ABSTRACT

Methods and systems for additively casting of a metallic object include constructing a mold region of a current production layer before producing the object region of the current production layer; depositing molten metal at a predetermined temperature in working areas at the object region of the current production layer according to a building plan; and moving one or more heaters over the deposition path and heating the working areas. The heating includes (1) heating the working areas to a pre-deposition target temperature before depositing metal on the working areas to affect a bonding of the molten metal with the working areas, and/or (2) heating the working areas to a post-deposition target temperature after depositing metal on the working areas to affect a thermal cooling profile of the working areas. the heating also includes providing annealing heating to earlier production layers by heat conduction through the current production layer.

### CROSS REFERENCE TO RELATED APPLICATIONS

This application claims priority from U.S. provisional patent application 63/224,658, filed Jul. 22, 2021, and from U.S. provisional patent application 63/283,980, filed Nov. 29, 2021, both of which are incorporated herein by reference.

### FIELD

The present invention relates to metal casting in general and, in particular, to apparatus and methods for improvements to additive metal casting.

### BACKGROUND

Most of the demand for cast metal products, especially for iron and steel, is currently met by traditional casting techniques, which involve the production of complete molds followed by the filling of the mold cavities with molten metal. In some cases, the production of molds includes fabricating a casting pattern from which the mold is made.

Production and management of casting patterns and molds introduce several factors that contribute significantly to the costs and turn-around times of traditional casting. Fabricating patterns and molds is both expensive and time-consuming, and using them in ongoing casting operations introduces the need for cleaning, maintenance, repair, and reconditioning.

In addition, long-term storage and inventory of patterns and molds can incur further significant expenses and management burdens. This effort may be justified for large-scale production of a particular cast metal part, but in an aftermarket situation, when market demand for that particular part diminishes, it may be difficult to justify the ongoing overhead of maintaining molds and patterns for the production of that part. When it becomes prohibitively expensive to continue manufacturing the part, the part's replacement availability typically becomes limited to existing inventories.

Additive manufacturing techniques may be used to fabricate patterns and molds individually on demand, thereby easing or eliminating the burden of long-term pattern and mold storage.

Traditional mold-based casting has other shortcomings: Large or complex castings often require molds with multiple pouring cups, runners, risers, and extensions, which account for a significant percentage of excess mold volume; in many cases, this can increase the amount of molten metal required for casting by as much as 50%. Although the excess metal may normally be remelted and reused, the energy expended in melting the excess metal is wasted. Another disadvantage of traditional casting is that particularly large or complex parts cannot always be cast in a single piece, thereby requiring welding and/or bolting of smaller parts together after casting.

Further disadvantages of traditional casting relate to the industrial safety hazards inherent in the process of handling and manipulating large amounts of molten metal, the high temperatures involved, and the toxic fumes typically accompanying the process. Along with the immediate safety hazards to manufacturing personnel, there are also issues of pollution and other detrimental environmental effects, all of which can have widespread and long-lasting consequences.

These considerations have motivated the development of various techniques for direct additive metal castings. Additive metal casting has the potential to obviate the problems and restrictions associated with patterns and molds, as discussed previously, and promises to confine molten metal to more easily managed amounts and extents in contained local environments to improve safety and minimize the effects of environmental hazards.

While potentially solving the mold and pattern-related problems of traditional casting, however, additive metal casting introduces its own restrictions and limitations: In terms of production flow, current additive metal casting techniques typically have limited throughput and have proven difficult to scale to large part sizes and masses.

Additive metal casting processes, in general, operate by repeatedly adding relatively small amounts of metal onto an existing casting-in-progress. The casting-in-progress is formed of a pre-selected metal and has at least one region with a pre-existing surface in the metallic solid state, onto which further amounts of the metal are incrementally added. Metal is added in the molten state, after which it quickly solidifies. This procedure is iteratively performed until the casting-in-progress has reached a predetermined size, shape, and mass of the metal and is thus a completed casting, ready for surface finishing procedures, if required.

Additive manufacturing systems are further described in the article “Shape Deposition Manufacturing” by Merz et al. (L. E. Weiss, R. Merz, F. B. Prinz, G. Neplotnik, P. Padmanabhan, L. Schultz, K. Ramaswami, “Shape deposition manufacturing of heterogeneous structures”, Journal of Manufacturing Systems, Volume 16, Issue 4, 1997, Pages 239-248, ISSN 0278-6125, https://doi.org/10.1016/50278-6125(97)89095-4, https://www.sciencedirect.com/science/article/pii/S0278612597890954).

In prior art over-heating (or superheating) techniques, by controlling the superheat of the droplets and the substrate temperature, conditions can be attained, such that the impacting droplets superficially remelt the underlying material. Temperature gradients between the molten droplets and the substrate article embedded in a sacrificial support structure are minimized during molten droplet deposition by increasing the substrate temperature—up to a certain level to prevent melting of the sacrificial support structure. However, thermal and stress relief are not resolved.

One of the detrimental consequences of exposing metals to high temperatures is oxidation, and additive casting is especially vulnerable to oxidation on account of the large surface area accumulated by the metal when it is in the molten state. Additive casting should preferably be conducted in an oxygen-free environment. Yet even if the oxidation problem is solved, there remain additional metallurgical factors, as discussed below.

Although considerable attention has been given to attaining the desired size, shape, dimensions, and finish when additively casting objects, inadequate attention has been directed to the metallurgical consistency and quality of the additive casting process itself, with the consequence that additively-cast metal parts are not optimized for applications demanding high tensile strength and stress tolerance.

Consequently, despite the potential advantages of additive metal manufacturing, the high costs, low throughputs, scaling difficulties, and metallurgical challenges prevent the adoption of additive techniques for widespread industrial use, especially for manufacturing high-performance metal components.

There thus is a need for additive metal casting methods and apparatus that facilitate high-volume manufacturing at a reduced cost, increased throughput, and high metallurgical quality and consistency. These goals are met by embodiments of the present invention.

### SUMMARY

Embodiments of the present invention provide methods, apparatus, and systems for the additive casting of metals based on iterative processing of sequentially-bonded production layers defined by fabricated mold regions whose mold cavities are filled by deposited molten metal, where the inner walls of the mold cavities define the shapes of the object regions, and hence the shape of the cast object, just as in traditional casting.

According to an aspect of the invention, there is provided a casting method for additively casting of a metallic object by producing multiple production layers having mold regions and object regions defined by the mold regions, one current production layer after the other up to a top production layer, comprising: constructing a mold region of the current production layer before producing the object region of the current production layer; moving a molten metal depositor over a deposition path and depositing molten metal at a predetermined deposition temperature in multiple working areas at the object region of the current production layer according to a building plan; and moving one or more heaters over the deposition path and heating the multiple working areas, wherein heating the multiple working areas comprises at least one of: (1) heating the multiple working areas to a pre-deposition target temperature before depositing metal on the multiple working areas to affect a bonding of the molten metal with the multiple working areas, and (2) heating the multiple working areas to a post-deposition target temperature after depositing metal on the multiple working areas to affect a thermal cooling profile of the multiple working areas, and wherein heating the multiple working areas further comprises providing annealing heating to one or more earlier production layers by heat conduction through the current production layer.

In some embodiments, providing annealing heating to the one or more earlier production layers comprises, after producing the top production layer, providing annealing heating to one or more earlier production layers by heat conduction through the top production layer.

In some embodiments, providing annealing heating to one or more earlier production layers by heat conduction through the top production layer comprises moving the one or more heaters over the multiple working areas of the top production layer for one or more successive annealing heating cycles.

In some embodiments, xthe method further comprises changing a height of the one or more heaters above the top production layer after each of the successive annealing heating cycles.

The pre-deposition target temperature may be equal to or above a melting temperature of the metallic object. The pre-deposition target temperature may differ from the predetermined deposition temperature by no more than a predetermined temperature difference.

In each current production layer above a base layer, the mold region may constitute, with the earlier production layer, at least one cavity and wherein the molten metal is deposited within the cavity.

According to an aspect of the invention, there is provided a casting system for additively casting of a metallic object by producing multiple production layers having mold regions and object regions defined by the mold regions, one current production layer after the other on a movable build table up to a top production layer, the system comprising: a movable mold constructor operative to construct a mold region for a current production layer; a movable molten metal depositor operative to deposit molten metal at a predetermined deposition temperature in multiple working areas at the object region of the current production layer; at least one heater operative for heating the multiple working areas; at least one motion unit coupled to the movable build table, the movable mold constructor, movable molten metal depositor and the one or more heaters; and a controller operative to iteratively control at least the build table, mold constructor, molten metal depositor, at least one heater and the at least one motion unit to produce the metal object according to a predetermined build plan, wherein heating the multiple working areas comprises at least one of: (1) heating the working areas to a pre-deposition target temperature before depositing metal on the working areas to affect a bonding of the molten metal with the working areas, and (2) heating the working areas to a post-deposition target temperature after depositing metal on the working areas to affect a thermal cooling profile of the working areas, and wherein heating the working areas further comprises providing annealing heating to one or more earlier production layers by heat conduction through the current production layer.

The controller may be operative, after producing the top production layer, to providing annealing heating to the one or more earlier production layers by heat conduction through the top production layer. The controller may be operative to moving the one or more heaters over the working areas of the top production layer for two or more successive annealing heating cycles for providing annealing heating to the one or more earlier production layers by heat conduction through the top production layer. The controller may be operative to changing a height of the one or more heaters above the top production layer after each of the successive annealing heating cycles. The controller may be further operative to maintain a difference between the deposition temperature and the pre-deposition temperature to be smaller than a predetermined temperature difference.

The casting system may further comprise a working area temperature sensor communicatively connected to the controller. The working area temperature sensor is selected from a group consisting of: a pyrometer; and a thermal camera.

The pre-deposition target temperature may be a melting temperature, and the heater may be operative to create a melt pool of molten metal in the working areas before metal deposition.

### BRIEF DESCRIPTION OF THE DRAWINGS

FIG. 1a illustrates an additive metal casting method according to embodiments of the invention;

FIG. 1b through FIG. 1e conceptually illustrate a shortcoming of prior art additive metal casting techniques, leading to metallurgical inconsistencies and weaknesses in prior art additively-cast metal products.

FIG. 2 conceptually illustrates features and aspects of additive metal casting according to certain embodiments of the present invention.

FIG. 3 conceptually illustrates further features and aspects of additive casting according to further embodiments of the present invention.

FIG. 4a and FIG. 4b conceptually illustrate additive metal deposition according to related embodiments of the present invention.

FIG. 5 is a flowchart illustrating a method for additive metal casting according to an embodiment of the present invention.

FIG. 6 is a block diagram of functional units and the functional processing organization of a system for additive casting according to an embodiment of the present invention.

FIG. 7 conceptually illustrates a production floor plan of a contained system for additive metal casting according to various embodiments of the present invention.

FIG. 8a through FIG. 8f depict results of a metallurgical evaluation conducted on coupons of cast objects fabricated in accordance with an embodiment of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

According to an aspect of the invention, there is provided a metal deposition method and system thereof for the casting of an object additively by producing multiple production layers having mold regions and object regions defined by the mold regions, one current production layer after the other.

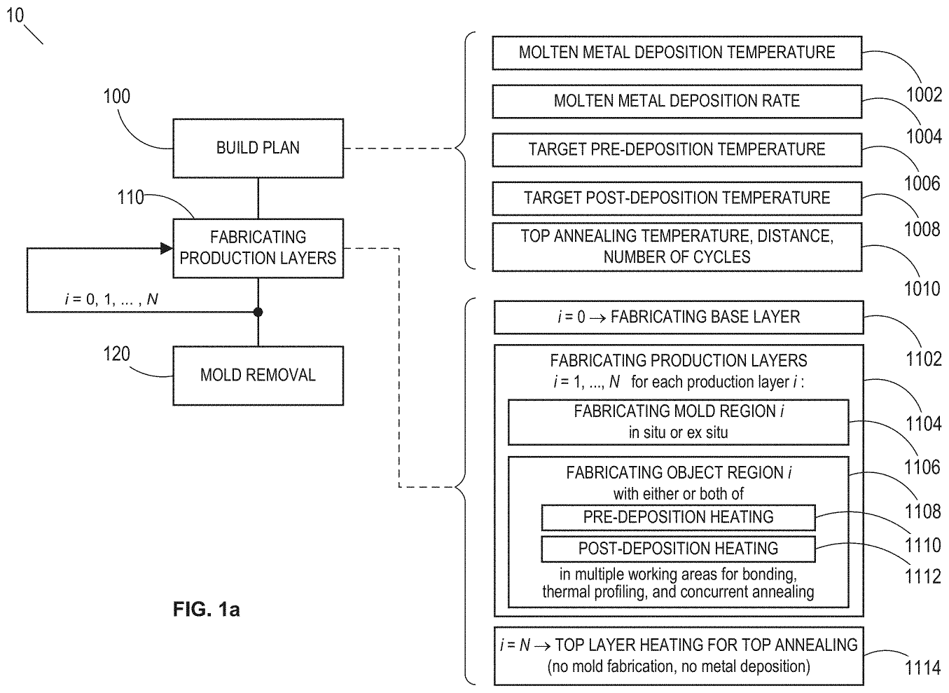

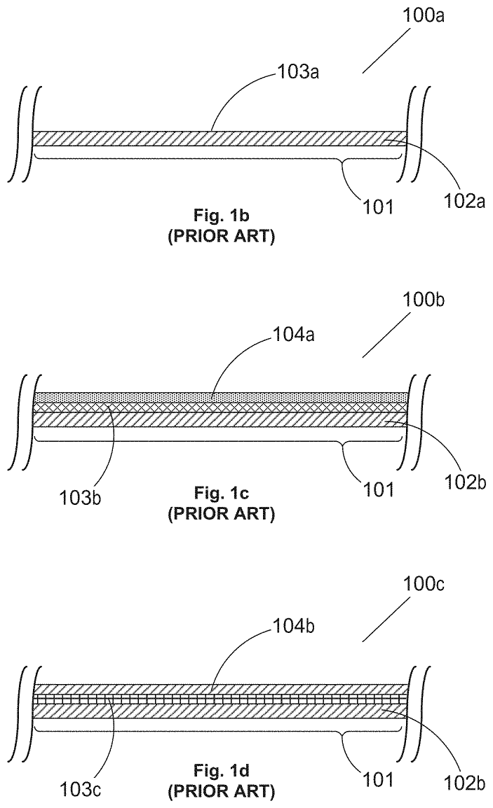

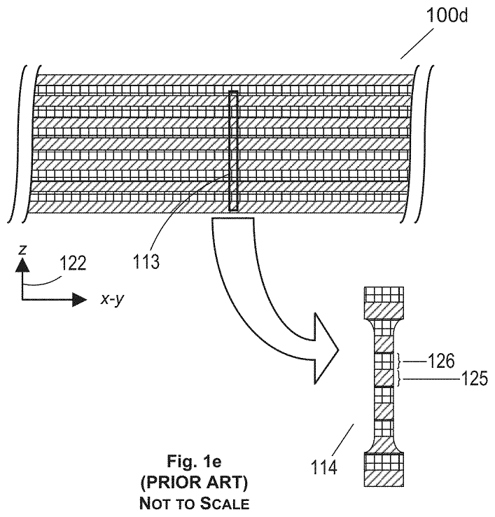

FIG. 1a illustrates an additive metal casting method 10 according to embodiments of the invention; FIG. 1b through FIG. 1e conceptually illustrate a shortcoming of prior art additive metal casting techniques, leading to metallurgical inconsistencies and weaknesses in prior art additively-cast metal products that are resolved by the method illustrated in FIG. 1a.

Additive metal casting following method 10 is done by iteratively fabricating, based on a build plan 100, a set of vertically-stacked production layers one upon another (operation 110), which, when the final production layer is completed, form the entire cast object inside its mold, prior to mold removal (operation 120). The fabrication of the production layers can start with the fabrication of a base layer (i=0) on a build table (operation 1102). The successive production layers i (i=1, . . . N) has a predetermined mold region (fabricated, in-situ, or ex-situ, in operation 1106) with at least one mold region cavity into which molten metal is deposited (operation 1108) after the mold region is complete.

The object region of a production layer is fabricated in operation 1108: heat is provided to the molten metal before deposition. Heat is optionally provided to the object region of the previously-produced layer before depositing the object region of the current production layer (pre-deposition heating or pre-heating (operation 1110)). Optionally, heat is provided to the object region of the current production layer after it is deposited (post-deposition heating or post-heating (operation 1112)).

The heat that is provided to the object regions of the various production layers is aimed at achieving the following impacts:

(1) improving the bonding between the molten metal to be deposited and the previously-deposited molten metal. In some embodiments of the invention, bonding improvement is realized based on pre-deposition heating.

(2) influencing the metallurgical consistency and isotropy at the grain microstructure level, by controlling local thermal cycling profiles before, during, and after the additive deposition. In some embodiments, influencing the metallurgical consistency and isotropy is realized based on post-deposition heating.

(3) annealing previously deposited molten metal.

The annealing is realized as concurrent annealing and top annealing (operation 1114). Concurrent annealing involves utilizing the heat provided to the previous production layer by the deposited molten metal and either or both pre-deposition heating and post-deposition heating. Top annealing (operation 1114) involves providing heat to the top production layer at one or more heating cycles with no mold production operation and no metal deposition operation. In some embodiments, both concurrent annealing and top annealing are controllable.

Thus, each layer production iteration of the additive casting process includes two principal operations: first fabricating a mold region of the current production layer (operation 1106), and then depositing molten metal into the mold region cavity (or cavities) associated with the current production layer (operation 1108). Each layer production iteration is in turn followed by a successive iteration in which the next production layer is additively produced until the top (or final) production layer is finished. Each time, when the deposited molten metal for the current production layer has solidified, the mold region for the successive production layer is fabricated and then molten metal is deposited on top of the current production layer.

In some embodiments, 3, 5, 10, 20, 30, 40, and more layer production iterations are performed. In some embodiments, layer heights may range from 2 millimeters to 12, 15, or 20 millimeters. The earlier layers thus undergo concurrent annealing. Once all of the layer production iterations are complete, one or more top annealing iterations are performed.

The principal mold fabrication operation may include additional operations such as mold region hardening and mold inner wall finishing.

The principal object fabrication operation may include additional operations such as pre-deposition heating and post-deposition heating.

After one production layer is complete and before starting the fabrication of the next production layer, additional operations may be performed, such as production layer surface treatment.

The iteratively-added production layers fit tightly together such that the mold regions form a continuous and/or cohesive mold around the cast object. Mold regions may further include mold inserts and mold support structures. The first production layer, or base layer, may be produced with no object regions. As described in detail herein, an additive process according to the present invention ensures that the sequentially-deposited object regions of the cast metal are metallurgically bonded together and are seamlessly integrated into a single metallurgically-homogeneous object.

The term “production layer” herein denotes an iteratively-fabricated layer as part of the process for the additive casting of a manufactured product according to the present invention. A production layer incorporates a mold region typically having at least one mold region cavity into which molten metal is deposited and an object deposition region corresponding to each mold region cavity—an object deposition region is defined by the mold region/s and exists after the deposition of molten metal into the mold region cavity. The first (lowest) production layer is herein denoted as the “base production layer” (or simply as the “base layer”), and the final (highest) production layer is herein denoted as the “top production layer” (or simply the “top layer”).

The terms “mold fabrication”, “fabricating a mold region”, etc., denote any combination of:

constructing a mold region (such as by deposition of a mold material which subsequently hardens or is hardened by the construction process and/or by assembling previously-made hardened component parts of a mold region); and

optionally finishing one or more inner surfaces of a mold cavity of the mold region, such as by milling, grinding, smoothing, polishing, etc.

The terms “production layer fabrication”, “layer fabrication”, “fabricating a production layer”, etc., denote a combination of: (1) fabricating a mold region that, in combination with a previously-produced layer, constitutes a mold cavity; (2) optionally, finishing inner walls of the mold cavity, for example by milling, grinding, smoothing, polishing, etc. (3) depositing molten metal in the mold region cavity of the mold region to produce an object deposition region; and (4) optionally finishing and/or leveling the top surface of the production layer, including both the mold region(s) and the object region(s), such as by milling, grinding, smoothing, polishing, etc.

The term “depositing” is used in its general sense, without limiting the rate of deposition. The term “depositing” thus covers the placement of molten metal drops as well as a stream of molten metal. The deposition of molten metal within the mold cavities may equally be referred to as filling the mold cavities by pouring molten metal and casting the object region within the mold region of a production layer.

It is noted that the optional finishing of the inner surfaces (walls) of a mold cavity is done before the deposition of metal in the mold cavity, whereas the optional finishing and/or leveling of the top surface of the production layer is done after the deposition of metal. That is, finishing of the inner surfaces of the mold cavities is performed during fabrication of a production layer, after mold region fabrication and before molten metal deposition. Finishing and/or leveling of the top surface of a production layer, however, is done between the fabrication operations of two sequential production layers.

In some embodiments, several molten metal deposition iterations are performed before the object region of a specific production layer is complete.

In some embodiments, several mold fabrication iterations are performed before the mold region of a specific production layer is complete.

In some embodiments, the fabrication of the object region (operations 1108 with either or both of operations 1110 and 1112) is performed additively, as multiple deposition and heating iterations carried out on multiple working areas that constitute the object region.

Build plan 100 includes at least data values relating to the molten metal deposition temperature 1002, molten metal deposition rate 1004, target pre-deposition temperature 1006, target post-deposition temperature 1008 and top annealing distance, number M of annealing cycle repetitions, and annealing temperature 1010.

After mold removal, additional cast treatment operations may be carried out, as known in the art, such as full annealing heat treatment, final machining, and inspection.

### Improvements Over the Prior Art

Pre-heating and post-heating of the metal layers as provided by embodiments of the invention assure metallurgical consistency and isotropy at the grain microstructure level, by controlling local thermal cycling profiles before, during, and after the additive deposition. Further, pre-heating and post-heating of the metal object regions in the various layers as provided by embodiments of the invention assure annealing of the deposited molten metal. In some embodiments, full annealing may be achieved, obviating the need to provide the cast (object) a dedicated annealing process, thereby shortening the overall casting duration.

Embodiments of the invention not only overcome the metallurgical inconsistencies and discontinuities that accompany prior art additive metal fabrication techniques, but also provide the ability to control local thermal profiles and annealing for desirable alterations in the metallurgical properties of the cast object from one point to another, according to the functional requirements of the cast.

In a non-limiting example, all sections of the cast undergo a similar heat treatment upon production, independent of their positioning with respect to the mold. Embodiments of the invention provide repeatable and controllable bonding, thermal cycling profiles and annealing, ensuring structural homogeneity.

In another non-limiting example, one section of the cast object requires optimized hardness, while another section requires optimized ductility. Embodiments of the invention provide localized, controllable heat treatment for attaining the different properties in different sections of the object.

Embodiments of the present invention also provide high metal deposition rates to increase the throughput of the additive casting process. In addition, embodiments of the present invention provide a contained environment for a production facility, to counter oxidation, increase safety, and prevent exposure to hazardous materials and effluents.

FIG. 1b- FIG. 1e. FIG. 1b conceptually illustrates a prior art working area 101 of a casting-in-progress in an initial state 100a before incremental adding of metal, and having a solid bulk body 102a of the metal in a state and extent with a solid surface 103a.

FIG. 1c conceptually illustrates a prior art resulting state 100b of the casting-in-progress after incrementally adding amounts of the metal by selectively depositing a predetermined small additional amount 104a (herein denoted as “small additional amount”) of the metal in a molten, or liquid, state onto working area 101. The heat of molten metal 104a raises the temperature of pre-existing solid surface 103a (FIG. 1b) and transforms the pre-existing surface into a partially-melted local boundary 103b, so that the body is now in a slightly altered extent 102b.

Partially-melted local boundary 103b between molten metal 104a and solid body 102b has substantially the same shape as that of pre-existing solid surface 103a (FIG. 1b). In many cases, solid surface 103a is a horizontal plane surface (as illustrated in FIG. 1b), but this example is non-limiting, and other shapes and orientations are possible.

Solid body 102b provides a heat sink to draw heat from local boundary 103b and molten metal 104a, and as heat is removed from local boundary 103b and molten metal 104a, their respective temperatures will decrease, eventually causing both molten metal 104a and local boundary 103b to fully solidify. FIG. 1d shows a resulting state 100c after solidification, with a fully solidified local boundary 103c and a solidified layer of the added metal 104b. Without applying additional treatment, local boundary 103c may be regarded as a Heat Affected Zone (HAZ), which is in a metallurgically-differentiated state from the ordinary solidified metal.

FIG. 1e illustrates the anisotropy of cast objects produced by prior art over-heating additive metal casting. By controlling the superheat of the droplets and the substrate temperature, conditions can be attained such that the impacting droplets superficially remelt the underlying material. Temperature gradients between the molten droplets and the substrate article embedded in a sacrificial support structure are minimized during molten droplet deposition by increasing the substrate temperature—up to a certain level to prevent melting of the sacrificial support structure. However, thermal and stress relief are not resolved.

FIG. 1e shows an edge view of a prior art metallurgical sample (generally known as a “coupon”) 113 taken from the region state 100d, taken after prior art incremental additive steps. Coupon 113 is taken vertically, i.e., along a z direction 122. A plane view 114 of coupon 113 shows a non-uniform microstructure, represented as repeated layers of two different zones: (1) a zone 125 having a first microstructure, corresponding to the normally-cast body of the metal in state 102a (FIG. 1b); and (2) a zone 126 having a second microstructure, associated with Heat Affected Zone boundary 103c (FIG. 1d)

In summary, coupon 113 reveals a bi-modal microstructure induced by the layer-upon-layer deposition procedure of prior art additive metal casting process.

The illustrated anisotropy is a serious shortcoming of prior art additive metal casting processes, because it introduces casting defects into the finished product. Such defects have an adverse effect on the material strength, structural integrity, and other mechanical properties of the cast object, and thereby diminish the quality and reliability of products manufactured by prior-art additive metal casting processes.

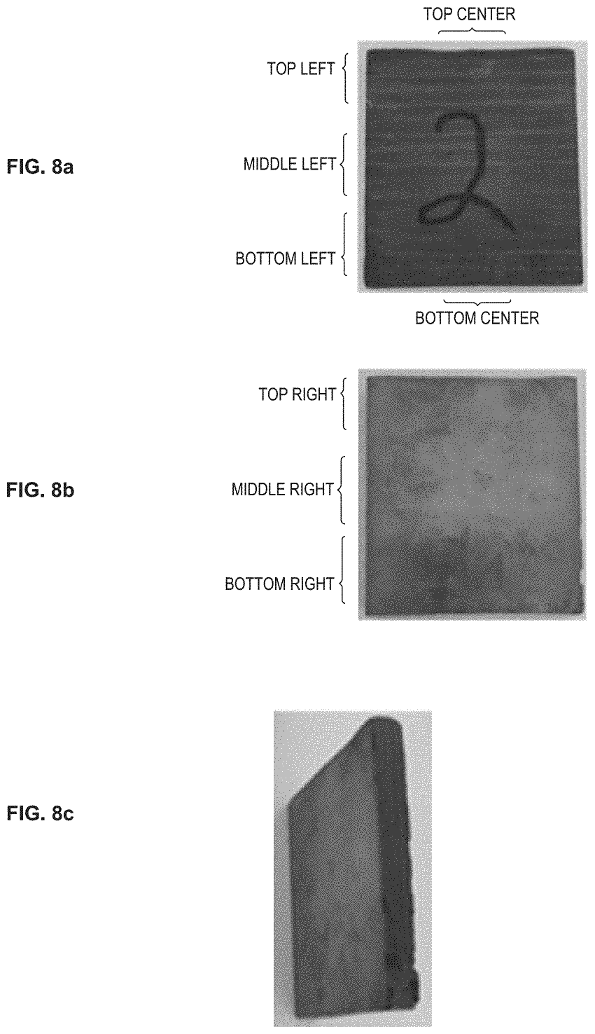

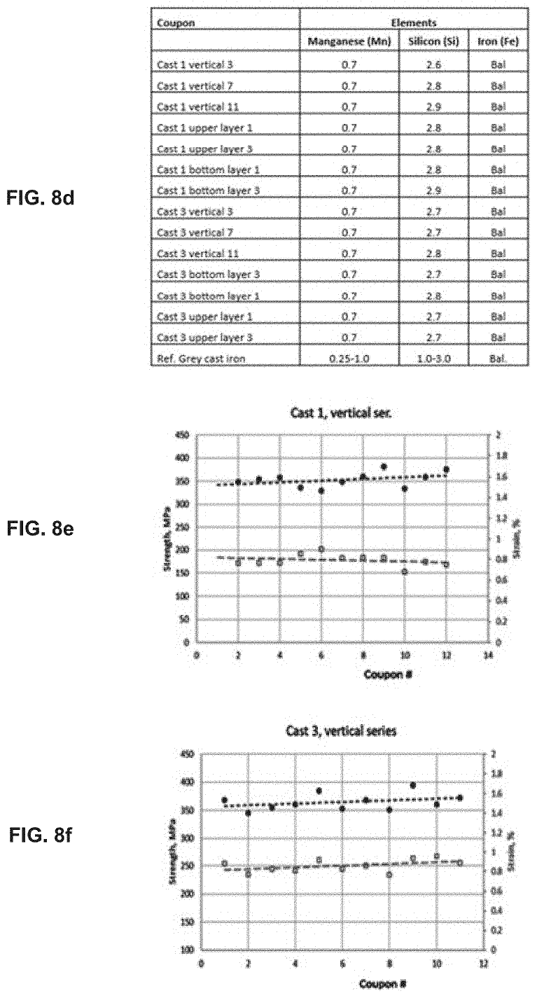

Embodiments of the invention overcome anisotropy shortcomings, as described herein with reference to FIGS. 1A, 2-7, and exemplified in FIGS. 8a-8f by results of a metallurgical evaluation conducted on coupons of cast objects fabricated in accordance with an embodiment of the present invention.

Layout and Fabrication of Sequential Production layers

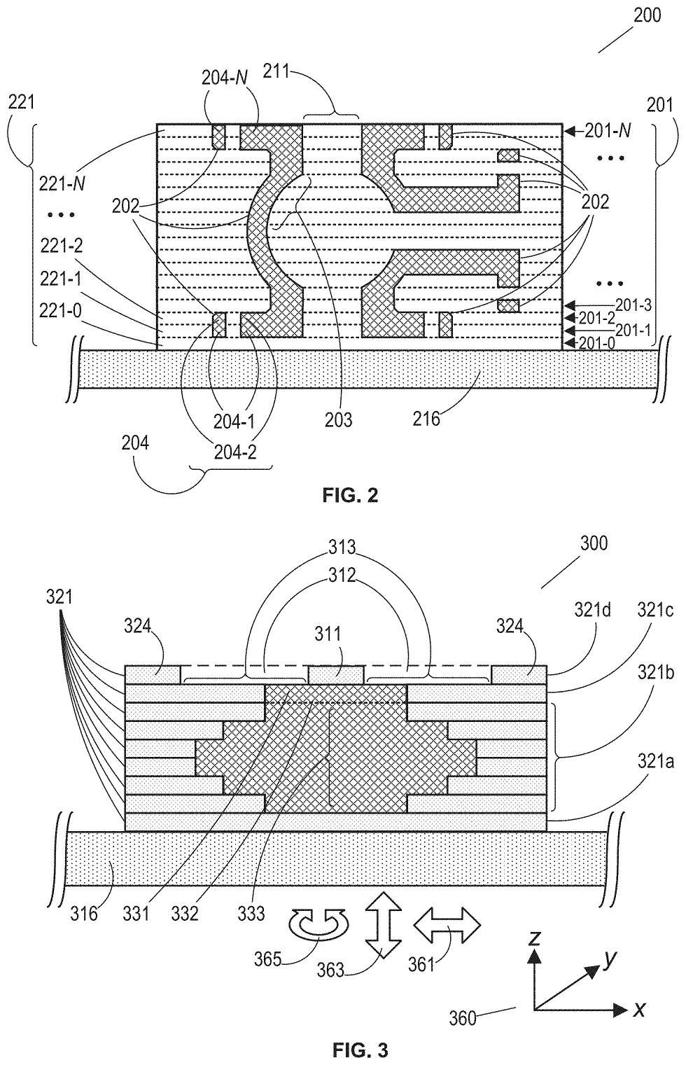

FIG. 2 is a cross-section view which conceptually illustrates features and aspects of a cast metal object 200 inside its mold (prior to mold removal) which was additively-cast according to an embodiment of the present invention. In this non-limiting example, object 200 is a valve body with hollow internal features formed by the presence of a mold insert 211. The mold regions of mold insert 211 are formed in the same manner as other mold regions, as described below.

It is noted that FIG. 2 shows nine distinct object sections 202, but these are all connected together to form object 200—a single object. FIG. 2 is a two-dimensional cross-section of object 200 inside its mold, and the connections between the nine distinct object sections are three-dimensional features which do not appear in FIG. 2.

The term “mold material” herein denotes a substance or mixture of substances which can be formed into mold, which when hardened, is suitable for casting molten metal. Non-limiting examples of mold materials include ceramics and sand.

The term “object region” herein denotes a region of metal in a production layer that has been cast into the mold region of a production layer or any part thereof during the additive casting process. The term “object material” herein denotes the metal which is melted and used for casting, whether in raw form prior to casting, in molten form during casting, or in solidified form after casting.

The term “metal” herein denotes any metallic element or metallic alloy suitable for melting and casting, non-limiting examples of which include: ferrous alloys, aluminum alloys, copper alloys, nickel alloys, magnesium alloys, and the like. Non-limiting examples of metals of special interest with respect to the present invention include: gray iron, ductile iron, and steel. In contrast, prior art additive metal casting typically is restricted to aluminum alloys, and typically excludes iron and steel. Embodiments of the present invention are responsive to the need for low cost and high throughput rates for additive metal casting of gray iron, ductile iron, and steel.

According to some embodiments, object 200 is cast in a series of sequential production layers 201 on a horizontal build table 216. According to embodiments of the invention, multiple sequential production layers 201 are iteratively fabricated in a vertical stack. In some embodiments of the invention, one or more bottom layers (or “base layer”) 201₀ are completely dedicated to mold material, and forms only a lower surface for one or more mold cavities of the production layer above. In these embodiments, no metal is deposited until after the mold regions of the production layer above are fabricated. Except for such a base layer 201₀, production layers 201ᵢ (i=1, . . . N) include one or more mold regions 221ᵢ (i=1, . . . N) defining one or more mold cavities for receiving molten metal to fabricate object regions 204. Production layers 201 are sequentially fabricated such that at least one mold region 221; of a layer i remains in tight contact with, and adhering to at least one mold region in the layer below (i−1) (for production layers above the base layer), and also is in tight contact with, and adhering to, at least one mold region in the layer above (i+1) (for production layers below the top layer).

In FIG. 2, the mold regions 221 of production layers 201 are shown with dotted lines representing the common surfaces between them. This is to indicate that the mold regions of the production layers were fabricated at different production cycles, and are in tight contact and adhere one to another. For clarity and simplicity of illustration, in subsequent figures, the boundaries between mold regions of different production layers are shown simply as solid lines.

Although molten metal is deposited in discrete operations during the course of iterative fabrication of the production layers, it is important to emphasize that the present invention provides novel manufacturing operations to ensure production of a finished cast metal object which is metallurgically homogeneous and isotropic in its microscopic grain structure, without any discernible boundaries corresponding to the production layers. In effect, the “production layers” are a feature of the invention's iterative process only, and are not a feature of its finished cast metal product.

In some embodiments, production layers typically range in thickness from about 2 millimeters to 12, 15 and 20 millimeters. (In the accompanying drawings, the thicknesses of the production layers is not necessarily to scale, and may be exaggerated for clarity of illustration.)

According to embodiments of the present invention, the creation of sequential production layers 201 and their component regions (mold regions 221, object regions 204) is done according to a predetermined build plan, which specifies at least: the geometric layouts of the different production layers and the component regions, as well as the materials involved, the operational processes to be performed, the parameters to be used in the fabrication (including without limitation time durations, temperatures, rates of deposition, and positions of features), as well as any other relevant information and data that will be necessary or useful during the additive casting process according to the present invention.

In FIG. 2, each production layer 201 was begun by fabricating a mold region (such as a mold region 221_{N}, shown for a top production layer 201_{N}). In a related embodiment, mold regions 221ᵢ (n=i, . . . N) were in-situ fabricated of formable mold material which were subsequently hardened to begin the production layer; in another related embodiment, pre-made hardened mold regions 221ᵢ (i=1, . . . N) were placed or assembled in place to begin production layers.

In the case illustrated by FIG. 2, after fabricating one or more mold regions for a production layer 201i, object regions 204ᵢ were fabricated by depositing molten metal into the mold region cavities 202ᵢ defined by the mold regions 221ᵢ of that particular production layer 201i.

The object regions 204ᵢ were allowed to cool and/or solidify within the current production layer i before additively fabricating a subsequent production layer i+1 upon the current layer i. This incremental additive process—fabricating mold regions for a production layer, then depositing molten metal in the mold cavities, and then allowing the metal to solidify—was iterated as many times N as needed to complete the casting of the entire metal object 200. In some embodiments, the number N of production layers may range between 3 to 20, 30, 40, 50 and more.

Mold regions for a production layer typically define the inner walls of a mold cavity. In a related embodiment, the lower surface of a mold cavity is defined by the previous underlying production layer, which may include both mold and metal portions. In another related embodiment, at least a portion of a lower surface of a mold cavity is defined by a mold region of the current production layer.

It is understood that mold regions 221 are capable of enduring the high temperatures associated with the molten metals of the casting process. In addition, according to various embodiments of the invention, the surfaces of mold regions that define the mold cavities (the inner walls of the mold cavities) are shaped and treated to provide a precisely-shaped and finished surface for the cast object. A section 203 in FIG. 2 highlights such a surface for object 200. Section 203 was shaped and treated to provide a precise and smooth spherical surface for the inner working surface of the valve body that was cast. In a related embodiment, at least part of the shaping and treating of the mold cavity surface is performed before the mold region is hardened; in another related embodiment, at least part of the shaping and treating of the mold cavity surface is performed after the mold region is hardened, such as by milling, grinding, and/or polishing.

In some embodiments, mold regions 221 are fabricated in-situ, for example by depositing mold material. In some embodiments, excessive mold material is deposited, yielding out-of-shape mold structure (for example, due to the viscosity of the mold material). The excessive mold material is them removed and the inner walls of the cavities are further treated and smoothen. It should be noted that the outer surface of the object regions 204 is shaped by the shape and surface smoothness of the side surface (inner walls) of the corresponding mold regions 221.

Precise shaping, treatment, and finishing of the side surfaces of mold regions for example, the inner walls of the mold cavities (as discussed above) is illustrated only in FIG. 2. For simplicity and clarity in the other drawings, and to clearly indicate the boundaries of production layering, the sides of the mold cavities in other drawings are represented as simply vertical.

According to some embodiments of the invention, which can be combined with other embodiments described herein, after fabricating a production layer i (including mold regions 221i and solidified object regions 204i, the upper surface of the production layer i is treated and finished prior to fabricating the next production layer i+1. Treating and finishing the upper surface of a production layer ensures that the layer will be level and will have the proper thickness, that excess mold and/or solidified metal will be removed; and that the upper surface of the layer will be smooth and even. Treatment and finishing includes, but is not limited to processes such as milling, grinding, and/or polishing by physical and chemical means.

In cases where treatment and finishing of mold and object regions is performed by ablative processes that produce residue (such as cutting, milling, grinding, polishing, laser trimming, etc.), the unwanted residue is removed prior to subsequent operations (depositing molten metal, fabricating the next production layer, etc.). Removal methods can include vacuum-cleaning operations, pressurized gas blow-off (using an inert gas, for example), and so forth.

According to some embodiments of the invention, which can be combined with other embodiments described herein, after completing the treatment of one production layer and before turning to the fabrication of the next production layer, height adjustments are provided. For example, build table 216 may be lowered an incremental distance corresponding to the height of the production layer.

FIG. 2 Illustrates a cross-section of cast object 200 still inside mold regions 201. To complete the process of additive manufacture of object 200, the mold structure 221 that is composed of mold regions 221i, is removed. In some embodiment, at least a portion of mold regions 201 are removed mechanically; in some embodiments, at least a portion of mold regions 201 are removed by other means, such as by dissolving and/or by chemical means. According to some embodiments of the invention, which can be combined with other embodiments described herein, object 200 is further treated and finished after mold removal.

The fabrication of object 200 is carried out additively by producing multiple fabrication layers. The additive nature of the present invention encompasses repetitive and optionally additive operations carried out as part of the fabrication of each production layer. In some embodiments, several mold fabrication iterations are needed for fabricating the mold region of a specific production layer. In some embodiments, several metal deposition iterations are needed for fabricating the object region of a specific production layer.

In some embodiments, the principal operation of mold region fabrication is carried out iteratively within production layer i, on multiple locations (not shown in FIG. 2), by traveling a mold fabrication system over the build table 216 and additively dispensing mold material to form mold region 221i. In some embodiments, the additional mold-fabrication operations (e.g., mold hardening, mold surface treatment) are carried out iteratively, one location after the other. In some embodiments, the additional mold-fabrication operations (e.g., mold hardening, mold surface treatment) are performed over the entire mold region of a layer.

In some embodiments, the principal operation of object region fabrication is carried out repeatedly and iteratively within production layer i on multiple working areas (not shown in FIG. 2), one working area after the other, by traveling a molten metal deposition system over the build table 216 and additively depositing (pouring) molten metal to form object region 204ᵢ. In some embodiments, one or more of the additional object-fabrication operations (e.g., pre-deposition heating, post-deposition heating) are carried out iteratively, one working area after the other. In some embodiments, the additional object-fabrication operations (e.g., pre-deposition heating, post-deposition heating) are performed over the entire object region of a layer.

Metallurgical Processing

The additive casting process according to various embodiments of the invention also includes specific heat treatment and thermal cycling operations before, during, and after deposition of molten metal. An apparatus for additive casting according to embodiments of the invention includes appropriate heaters and controllers for carrying out the specific heat treatment operations. These embodiments and their features provide special improvements that not only overcome the previously-described shortcomings of prior-art additive metal casting techniques but also provide advanced metallurgical manufacturing capabilities, and are disclosed in detail below. The methods and apparatus of embodiments of the invention provide manufactured metal objects which do not exhibit vestiges of additive metal layering. Instead, embodiments of the present invention provide annealed metal objects which have homogeneous, isotropic, and fully-controlled metallurgical and mechanical properties.

FIG. 3 is a cross-section view which conceptually illustrates features and aspects of a metal object 300 within its mold which is in the process of being additively cast on a build table 316 according to certain embodiments of the present invention. Object 300 is simplified as a generic or non-specific cast object, and, as noted previously, in FIG. 3 the mold regions of production layers 321 are illustrated with simple vertical sides and may have exaggerated thicknesses.

In FIG. 3, a production layer 321d is in process, but has only a mold region 324 fabricated so far, including a mold region 311 which serves as a mold insert, thereby having a mold cavity 312. At this point, production layer 321d is denoted as the “current production layer” (or simply as the “current layer”), and a layer 321c directly underneath is denoted as the “previous production layer” (or simply as the “previous layer”). A base production layer 321a was first fabricated on build table 316, and production layers 321b were then added. For convenience, production layers between the base layer and the previous layer are denoted as “earlier production layers” (or simply as “earlier layers”).

According to a related embodiment, relative movement is provided between build table 316 and elements of a production system used for the fabrication of object 300 (not shown in FIG. 3). For example, the relative movement is provided on command from an electronic controller (not shown in FIG. 3), and can be realized side-to-side (in an x-direction 361), front-to-back (in a y-direction), up and down (in a z-direction 363) and rotated clockwise and counterclockwise 365 with respect to a coordinate system 360.

Various fabrication operations may involve the relative movement. In some embodiments, build table 316 may be moved along the z-direction 363 after a production layer is complete. In some embodiments involving, within a production layer, the fabrication of the object region and optionally the mold region by traveling over multiple working areas, the relative movement is provided on build table 316 along the x-direction 361, y-direction, and rotation 365.

In FIG. 3, a lower surface 313 of mold cavity 312 is shown. It is seen that lower surface 313 is a portion of the upper surface of previous layer 321c. Part of lower surface 313 is an upper surface of the mold region of previous layer 321c, and part of lower surface 313 is an upper surface of the object region of previous layer 321c.

In some instances, the mold region of production layer i covers the mold region of the previous production layer i−1. In some instances, a part or all of the mold region of production layer i covers the object region of the previous production layer i−1 (“mold over object”). In some instances, a part or all of the object region of production layer i covers part or all of the mold region of the previous production layer i−1 (“object over mold”).

With respect to object 300, which is still being additively cast according to an embodiment of the present invention, it is noted that no portion of the object region of object 300 is in base layer 321a, since in this embodiment base layer 321a serves to separate poured molten metal from build table 316.

For ease of explanation, the operations carried out on the previous layer 321c and earlier layers 321b are illustrated in FIG. 3 by showing an illustrative previous object region 331 having an illustrative lower surface 332 corresponding to the lower surface of previous production layer 321c. In practice, in some embodiments of the invention, there are no identifiable production layer boundaries within earlier object region 333—because the additive casting process according to embodiments of the present invention provides local heating and thermal cycling operations which have been carried out, and which have perfectly bonded the deposited molten metal with the earlier metal region. In some embodiments, the additive casting process provides local heating and thermal cycling operations which have been carried out, and which have fully (or partially) annealed the earlier object region to be homogeneous and isotropic, such that there remain no metallurgical boundaries corresponding to earlier production layers 321b. In practice, annealing may be reached after several successive thermal cycles and the metallurgical differences between the various production layers are not illustrated in FIG. 3. The specific local heating thermal cycling operations cited above are disclosed in detail below.

For simplicity of explanation, mold regions 324 of production layers are illustrated as maintaining their separate identification, however this is not necessarily so.

### Target Pre-Deposition Heating

According to some embodiments of the invention, which can be combined with other embodiments described herein, before the deposition of new molten metal into mold cavity 312 (FIG. 3) where there is a surface of the metal object region of the previous layer (object region 333 in FIG. 3), the upper surface of the previous layer's object region is prepared to bond metallurgically with the new molten metal that will fill mold cavity 312. This preparation is done according to embodiments of the invention, which provide a pre-deposition heating operation (also denoted herein as “target pre-deposition heating” and “pre-heating”) and a pre-heater (not shown in FIG. 3), for pre-heating the upper surface of object region 333 with enough heat energy at a “target pre-deposition temperature”. The heater moves over mold cavity 312 before a depositor (not shown in FIG. 3) moves mold cavity 312.

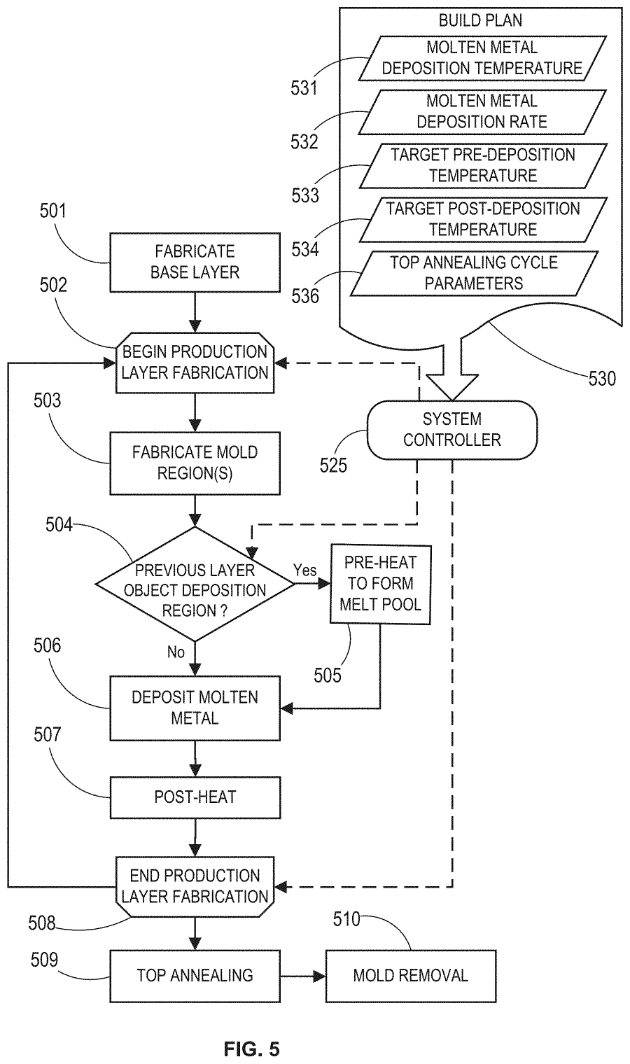

In some embodiments of the invention (denoted herein as “melt pool embodiments”), which can be combined with other embodiments described herein, the target pre-deposition temperature is the appropriate temperature to melt just the upper surface, and thereby form a melt pool. In a related embodiment, the target pre-deposition temperature is a predetermined constant temperature for a particular metal. In another related embodiment, the target pre-deposition temperature is a function (such as a function of the position of the object region in the cast object). In a further related embodiment, the target pre-deposition temperature is a data value provided by a build map (such as a target pre-deposition temperature data value 533 in a build plan 530 of FIG. 5).

In some embodiments (denoted herein as “over-heating embodiments”), which can be combined with other embodiments described herein, the target pre-deposition temperature is the appropriate temperature to sufficiently heat the upper surface such that molten-metal at a predetermined over-melting temperature will bond with the heated zone. In a related embodiment, the target pre-deposition temperature is a predetermined constant temperature for a particular metal. In another related embodiment, the target pre-deposition temperature is a function (such as a function of the position of the object region in the cast object). In a further related embodiment, the target pre-deposition temperature is a data value provided by a build map (such as a target pre-deposition temperature data value 533 in a build plan 530 of FIG. 5).

In this operation, the term “target” refers to the upper surface of the previous production layer object region, where the new molten metal will be deposited. After pre-heating, the new molten metal is deposited in mold cavity 312 in a deposition operation, as described below.

### Deposition of Molten Metal

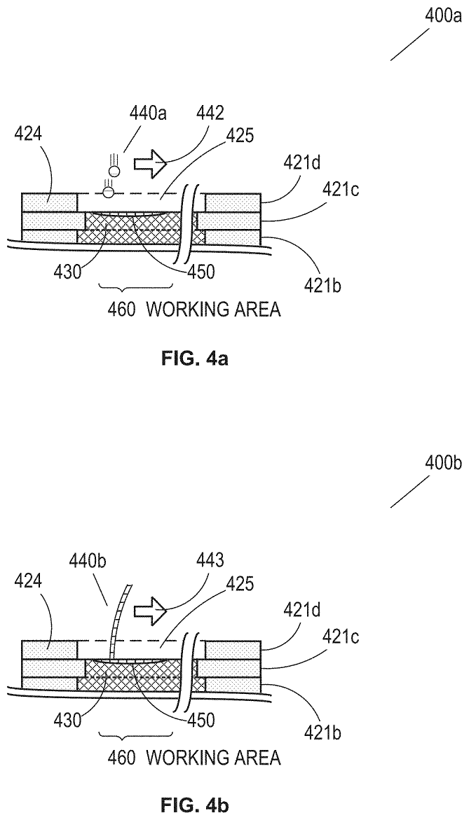

FIG. 4a and FIG. 4b conceptually illustrate operations of additive metal deposition according to related embodiments of the present invention. Both FIG. 4a and FIG. 4b show molten metal deposition into a mold cavity 425 within a mold region 424 in a current production layer 421d. Also shown are a previous production layer 421c, an earlier production layer 421b, and a previous object region 430.

As discussed before, the borderline between the previous production layer 421c and the earlier production layer 421b is of illustrative nature. In some embodiments, the mold regions of layers 421b and 421c may be fully bonded. In some embodiments, the object regions of layers 421b and 421c may be perfectly bonded, even if annealing is not performed in full.

FIG. 4a discloses one embodiment of the present invention, which provides discrete overlapping droplets 440a falling into mold cavity 425. FIG. 4b discloses another embodiment, which provides a continuous stream 440b pouring into mold cavity 425.

In the embodiments shown in FIG. 4a and FIG. 4b, molten metal—whether in discrete droplets 440a or in continuous stream 440b— falls into the mold solely under the influence of gravity, and without any forcible injection into mold cavity 425.

In the embodiments shown in FIG. 4a and FIG. 4b, molten metal is provided in multiple working areas along a deposition path (arrow 442 in FIG. 4a and 443 in FIG. 4b). One such working area 460 is depicted in FIGS. 4a and 4b.

According to melt-pool embodiments of the invention, the target position for molten metal deposition is a working area 460 that includes melt pool 450. Melt pool 450 is formed by melting a small portion of the surface of the object region of previous production layer 421c. As noted above, pre-heating is supplied at a target pre-deposition temperature as needed to liquify a thin layer of metal at the surface of the previous layer's object region. A melt pool has surface dimensions which, in practice, range from about 1 millimeter to about 30 millimeters.

According to embodiments of the invention, molten metal should be distributed evenly throughout mold cavity 425 by moving a molten metal depositor across cavity 425 along the deposition path 442 as the molten metal is deposited (and making sure to move and/or extend melt pool 450 as necessary to remain under the deposited molten metal as the molten metal depositor is moved).

In order to fill the entire mold cavity evenly, it is usually necessary to scan the molten metal depositor to cover both the x- and the y-extent of the cavity. In some embodiments, the depositor and the heater are movable over the working areas WAs. A typical scanning style is a raster scan. In a non-limiting example of a rectangular mold cavity whose long sides are parallel to the x-axis, a raster scan might be done by starting in a corner of the cavity and depositing metal along the x-axis for the length of the cavity, keeping the molten metal depositor at a constant y position; and then incrementing y slightly to ensure adequate overlap (for continuous stream 440b as well as for droplets 440a), and reversing the x-axis motion of the molten metal depositor to deposit overlapping molten metal in the opposite direction, and so on until the entire area of the mold cavity has been covered. This scan is then repeated until the mold cavity is filled to the top. While scanning, the melt pool would be maintained by pre-heating under the deposition point. The raster scan can be readily adapted to handle other shapes of mold cavity, but other scans may be more efficient for specialized shapes. For example, a spiral scan may be better suited for filling circular mold cavities. In a related embodiment, precise data for the scan path is provided by the build plan.

According to some embodiments of the invention, which can be combined with other embodiments described herein, the heater and the depositor continuously move over the mold cavity 425. Thus, in the melt-pool embodiments, a continuous melt pool trail and continuous molten metal flow may be created. In each working area, the melt pool cools down behind the heater, while the depositor approaches the working area and moves above the working area. In some embodiments, over-melting heating is provided to compensate for the cooldown of the working area between the passage of the heater and the passage of the depositor.

Typically, a droplet of molten gray iron at a temperature comparable to that of a molten gray iron melt pool has a diameter of 6 millimeters to 8 millimeters. When releasing the droplets to fall into melt pool 450, the droplets may be overlapped to deposit molten metal evenly without gaps. For an overlap of 50% (i.e., the droplets overlap by half their diameter), the molten metal depositor should move at a maximum speed of nd/2, where d is the diameter of the droplets, and n is the number of droplets per second. In a non-limiting example, if droplet diameter d=8 millimeters and n=2 droplets/sec, then the maximum speed of the molten metal depositor is 8 millimeters/sec.

The rate of molten metal deposition is a parameter, that is denoted herein as the “molten metal deposition rate”. In some embodiments, the deposition rate is fixed. In some embodiments, the deposition rate may vary, for example in accordance with the build plan.

In some embodiments, only discrete overlapping molten metal drops are provided. In some embodiments, a continuous molten metal stream is provided. In some embodiments, molten metal may be deposited on some working areas as overlapping drops and in other working areas as a continuous stream.

In some embodiments, a continuous stream has a smaller diameter, approximately 3 millimeters, and can deposit approximately 4 cm³ per second of molten gray iron. In such embodiments, the smaller diameter of the continuous stream allows deposition of metal in finer dimensions and detail.

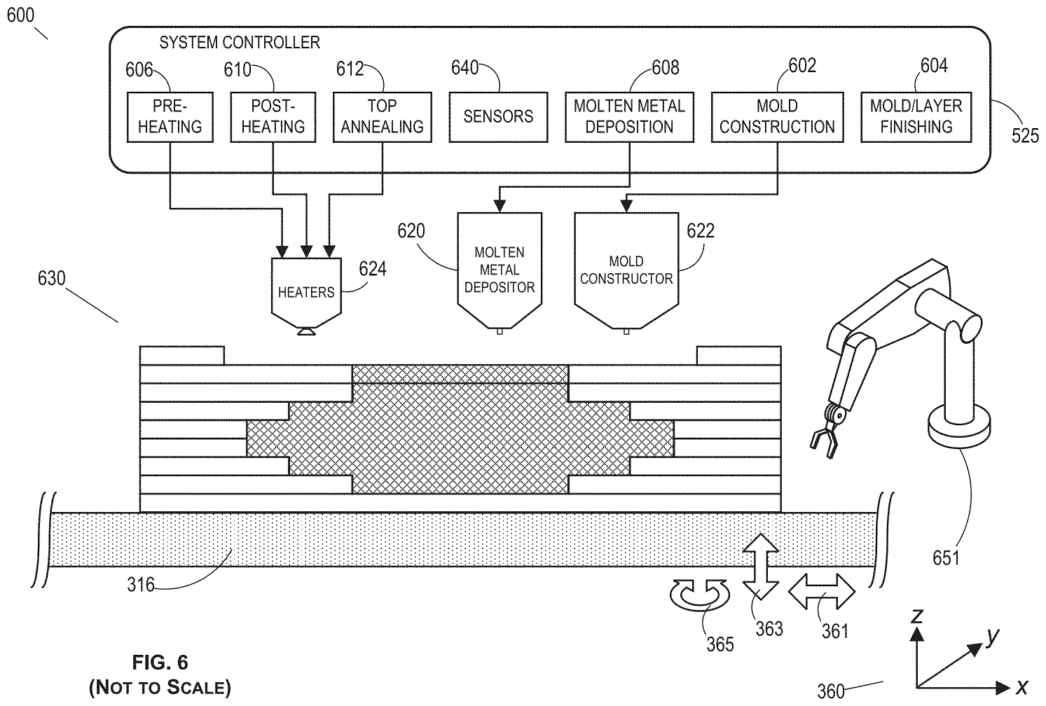

The molten metal deposition rate may vary according to details of the specific molten metal deposition being performed at the time (for example, depending on the scan speed of molten metal depositor 620 in FIG. 6). In a related embodiment, the molten metal deposition rate is a data value provided by a build map (such as a molten metal deposition rate data value 532 in a build plan 530 of FIG. 5).

Various embodiments of the invention may achieve casting rates of about 10 kilograms per hour, 20 kilograms per hour, 50 kilograms per hour, 100 kilograms per hour, up to 300 kilograms per hour and more.

In some embodiments of the present invention, which can be combined with other embodiments described herein, optimization of the bonding of the current layer's object region to the previous layer's object region is achieved by minimizing or eliminating thermal shock and by minimizing or eliminating metallurgical disparities between the newly-added metal in the current layer and the existing metal in the previous layer. Some embodiments of the present invention, do not rely on the added molten metal to supply thermal bonding energy, and do not put the added molten metal into a superheated state. For these reasons, various embodiments of the present invention adjust the temperature of added molten metal 440a and 440b to be as close as possible to the temperature of melt pool 450, preferably within 30 degrees Centigrade of one another, as determined by temperature sensing via pyrometers and/or thermal cameras, infrared cameras, and the like. The temperature of the molten metal for deposition is herein denoted as the “molten metal deposition temperature”. According to a related embodiment, the value of this parameter is provided by a molten metal deposition temperature data value 531 of build plan 530 in FIG. 5).

### Target Post-Deposition Heating

When molten metal is deposited in a mold cavity as described above, it comes into thermal contact with a large heat sink of solidified metal (shown in FIG. 3—bulk 333 composed of object regions of the earlier layers), and rapidly begins to cool. Uncontrolled rapid cooling, however, can alter the micrograin structure of the cast metal in an undesirable manner. To assure that cooling and solidification of the working area (including the newly added molten metal and together with the previous material e.g., the material of the melt pool) proceeds at a controlled rate, embodiments of the present invention provide a post-heating operation (also denoted herein as “target post-deposition heating” and “post-heating”) and a post-heater, for adding thermal energy as necessary to ensure that the cooling and solidification of the newly-cast metal proceeds at a proper rate. This temperature is denoted herein as the “target post-deposition temperature”. In a related embodiment, a “target post-deposition temperature” for the post-heating is a predetermined constant temperature for a particular metal. In another related embodiment, the target post-deposition temperature is a function (such as a function of time and/or the position of the object region in the cast object). In a further related embodiment, the target post-deposition temperature is a data value provided by a build map (such as a target post-deposition temperature data value 533 in a build plan 530 of FIG. 5).

According to a related embodiment, the value of this parameter is provided by a data value 534 of build plan 530 in FIG. 5).

### Concurrent Annealing

Metal that undergoes stress from thermal shock can acquire internal strain that degrades the metal's mechanical properties. In particular, the presence of Heat Affected Zones in a metal object fabricated by prior art additive metal casting techniques, as previously discussed, indicates the presence of such internal strain. Additive casting according to the present invention, however, provides concurrent annealing of the strains in the earlier object region of the cast object.

Annealing relieves the strains and restores the metal's properties. Annealing can be performed by controlled temperature cycling—such as by heating and then gradually cooling. According to embodiments of the present invention, when new molten metal is added to the object being cast (as disclosed above), the various processes involved introduce heat into the current production layer, which drains off, by heat conduction, into the earlier object region. That is, the earlier object region experiences a controlled thermal cycling as a result of being the primary heat sink for both the introduction of thermal heat from the added molten metal and also from either or both of the pre-deposition operation and the post-heating operation. This thermal cycling continues as each new production layer is added, but diminishes as the current production layer moves farther away from the early layers. The effect of two or three of pre-heating, molten metal addition and post-heating provides a concurrent annealing relief for Heat Affected Zone strains and anisotropy (previously discussed) of the earlier object region.

In a related embodiment, additional heating operations are performed and facilitate concurrent annealing, for example—for “mold over metal” scenarios. Several “mold over metal” scenarios are depicted in FIG. 2. It can be seen that in different production layers, some working areas of the object region at one layer are in direct contact with working areas of the object region at another layer (above or below). Some working areas of the object region at other layers are in direct contact with the mold region at another layer (above or below). The heat conductivity of the mold region is different than the heat conductivity of the object region. Thus, for concurrent annealing additional heating may be beneficial.

In some embodiments, the target post-deposition temperature is adjusted (e.g., made higher). In some embodiments, the travel velocity of the post-heater is adjusted (e.g., made slower). In some embodiments, additional heating is provided in parallel to the post-deposition heating of the object region. The additional heating may include one or more of: (1) heating and maintaining the build table at a selected temperature; (2) heating a production chamber encompassing at least the build table and maintaining the production chamber at a selected temperature.

In another related embodiment, the thermal cycling of the annealing process is controlled to adjust the specific metallurgical properties of a selected object region of the cast metal object.

For example, all sections of the cast object undergo a similar heat treatment upon production, independent of their positioning with respect to the mold regions. Embodiments of the invention provide repeatable and controllable thermal cycling profiles ensuring structural homogeneity over the entire cast.

In another non-limiting example, the casting of a metal object whose hardness needs to be varied from one region to another, such as an excavator bucket used in mining, can be implemented. The tips and outer surfaces of a bucket tooth need to be hard in order to function efficiently, but the inner body and shaft of the tooth should be resilient and flexible to resist breakage. These goals are achieved by embodiments of the present invention which provide different thermal cycling profiles for different working areas of object regions of the cast object, to achieve the metallurgical properties appropriate for those regions according to the specific functional requirements of the cast object.

In some embodiments, different thermal cycling profiles may be provided to different working areas within the same object region of a specific production layer.

In some embodiments, different thermal cycling profiles may be provided to different production layers.

### Top Annealing

According to embodiments of the present invention, and as noted above, annealing of earlier object regions occurs concurrently with the process of depositing new molten metal into mold cavities of the current production layer and the accompanying annealing thermal cycling. When the deposition of molten metal is complete, however, the final current production layer (top production later 201_{N} shown in FIG. 2), along with the final previous production layer and nearby object regions below will not experience concurrent annealing, because no further layers of molten metal will be deposited. Some embodiments of the invention provide “top annealing” for the object regions of the upper production layers.

In the top annealing embodiment, the thermal cycles of either or both of the pre-heating and post-heating are performed as if additional production layers were being added, except that no further mold regions are fabricated and that no further molten metal is deposited.

In a related embodiment, one or more moveable heater(s) are scanned over the top production layer. In some embodiments, one top annealing cycle is performed. In some embodiments, a series of successive top annealing heating cycles is performed. The number of the successive top annealing heating cycles may be in the range of 1, 2, 3, 5, 10 or more.

In another related embodiment, the one or more moveable heater(s) are scanned over the top production layer in two or more successive annealing heating cycles, at a gradually increasing distance above the top layer. In some embodiments, the build table (element 316 shown in FIG. 3) is lowered in the z-direction 363 at a distance equal to a production layer height. In some embodiments, the moveable heater(s) is raised in the z-direction 363 at a distance equal to a production layer height. In some embodiments, the distance is in the range of 2 millimeters to 12 millimeters.

### Method for Additive Metal Casting

FIG. 5 is a flowchart illustrating a method for additive metal casting according to an embodiment of the present invention employing pre-deposition heating for melt pool creation and post-deposition heating. The operations of the method are controlled by a system controller 525 following a predetermined build plan 530. Build plan 530 has already been noted above, in connection with providing data values 531, 532, 533, 534 and 536 for molten metal deposition, molten metal deposition rate, pre-heating, post-heating and top annealing, respectively.

In operation 501 a base layer is fabricated (such as base layer 321a in FIG. 3). A loop beginning point 502 indicates the beginning of fabricating a production layer (such as current production layer 321d in FIG. 3) under control of system controller 525.

In operation 503 one or more mold regions of the current layer are fabricated according to Build Plan 530 (such as mold regions 324 and 311 of layer 321d in FIG. 3). Then, at a decision point 504, system controller 525 checks Build Plan 530 as to whether or not the previous production layer has a metal object region surface in the mold cavity. If No (such as in the case of the production layer immediately above base layer 321a in FIG. 3), then system controller 525 proceeds directly to operation 506 and deposits molten metal into the mold cavity defining the object region. In some embodiments, molten metal is deposited while moving over multiple working areas (working areas 460 illustrated in FIGS. 4a-4b). If Yes, however, (such as in the case of current production layer 321d with metal object region 331 of previous layer 321c in FIG. 3), then system controller 525 performs an operation 505, and directs a heater to pre-heat the object region surface (heat the working areas) to form a melt pool (as melt pool 450 of FIG. 4a and FIG. 4b), as disclosed previously in the section on “Target Pre-Deposition Heating”, and in accordance with target pre-deposition temperature data value 533, as also previously described.

For example, for the production of a gray iron object, the molten metal deposition temperature may be 1150 degrees Centigrade or above. The target pre-deposition temperature of the working areas—immediately upon molten metal deposition is 1150 degrees Centigrade or above.

In some embodiments, the deposition temperature and the pre-deposition temperature are sensed and controlled such that the pre-deposition target temperature differs from the predetermined deposition temperature by no more than a predetermined temperature difference. In some melt pool creation embodiments, the molten metal deposition temperature and the pre-deposition temperature of the receiving area—the working areas—are ideally identical (predetermined temperature difference=0).

In some embodiments, the predetermined temperature difference is in the range of 10-50 degrees centigrade. In some embodiments, for example, to compensate for inevitable system fluctuations and other temperature fluctuations (for example, attributed by the movement of the depositors and heaters over the object regions, the predetermined temperature difference is 30 degrees Centigrade.

In some embodiments, a melt pool of 15-25 millimeters width, for example 17 millimeters, which provides a depth of 3-10 millimeters, for example, 5 millimeters, is sufficient to receive a volume of molten metal of about 1 cm³ and perfect bonding may be achieved.

In operation 506, system controller 525 controls a molten metal depositor to deposit molten metal in the mold cavity (as illustrated in FIG. 4a and FIG. 4b), in accordance with molten metal deposition temperature data value 531 and molten metal deposition rate data value 532, as previously described.

In operation 507, system controller 525 directs a heater to post-heat the deposited metal, to control the cooling rate of the molten metal and impact the concurrent annealing, as disclosed previously in the sections on “Target Post-Deposition Heating” and “concurrent annealing”, and in accordance with target post-deposition temperature data value 534, as also previously described.

At a loop end point 508, system controller 525 checks Build Plan 530 as to whether there are any further production layers. If there are, system controller 525 repeats from loop begin point 502 for the next production layer. Otherwise, system controller 525 continues to an operation 509 and performs top annealing for the final production layers, as detailed above in the section on “Top Annealing”.

After the top annealing, the method concludes at an operation 510, in which the mold is removed.

As noted previously, the cast metal object may be treated and finished if needed.

In another embodiment of the present invention, the above method and variations thereof are performed by a system as directed by an automated controller.

In some embodiments, operations 505 (pre-heat to form melt pool), 506 (deposit molten metal) and 507 (post heat) are carried out additively on multiple working areas constituting the object region of the current production layer. In some embodiments, one working area after another undergo pre-heating, metal deposition and post heating by a traveling depositor and one or more heaters that scan the object region.

In some embodiments, the working areas are maintained in an inert environment to thereby reduce or eliminate oxidation of the melt pool. In some embodiments, in addition to being maintained in an inert environment, the molten metal to be deposited and the melt pool are maintained at the same temperature (or substantially the same, for example, up to a 30 degrees Centigrade difference). In combination with concurrent annealing and top annealing, the molten metal to be deposited and the melt pool are maintained under the same (or substantially the same) rheological conditions. As a result, a metallic object with perfect bonding between production layers, fully (or partially) annealed and with highly-homogenous structure may be achieved. Experimental results will be discussed in the Appendix with reference to FIGS. 8a-8f.

In some embodiments, which can be combined with other embodiments described herein, no post-deposition heating is provided and heat is provided only before metal deposition.

In some embodiments, which can be combined with other embodiments described herein, no pre-deposition heating is provided. For example, the molten metal to be deposited is superheated, and the heat is provided to the working areas only after metal deposition.

For ease of explanation, embodiments of the invention were described with reference to a constant heating regime that is applied to the entire stack of production layer—however this is not necessarily so. In some embodiments, different production layers may experience different heating regimes.

For ease of explanation, embodiments of the invention were described with reference to a constant heating regime that is applied to the multiple working areas of the object region in a production layer—however this is not necessarily so. In some embodiments, different working areas may experience different heating regimes comparing other working areas of the object region of the same production layer.

FIG. 5 focuses on the melt-pool embodiments of the invention, however the invention is not limited thereto. According to other embodiments of the invention (referred to herein as over-heating (or superheating) embodiments), the molten metal to be deposited may carry some of the energy to be conveyed to the working area (for example, by over-heating the molten metal to be deposited above a metal melting temperature). In these embodiments, pre-deposition heating may comprise heating the working area in the object region to a below-melting state.

### System for Additive Metal Casting

FIG. 6 is a block diagram of functional units and the functional processing organization of a system 600 for additive casting according to an embodiment of the present invention.

A movable mold constructor 622, a movable molten metal depositor 620, and one or more movable heaters 624 perform key operations of the present invention as previously described, and are physically located proximate to a casting-in-progress 630 positioned on build table 316. Heaters 624 include devices for the pre-heating and the post-heating previously-described. One or more robotic arms 651 (or any other motion device) is also capable of moving devices such as heaters 624, depositor(s) 620, mold constructor(s) 622 and surface treatment and finishing elements (not shown in FIG. 6).

During additive casting processes according to the invention, the movable units described above perform motions relative to casting-in-progress 630. Relative movement includes movement in the x-y plane as well as in the z direction (per coordinate system 360), and have degrees of freedom in horizontal motion 361, vertical motion 363, and rotation 365. According to the present invention, relative motions can be accomplished by moving build table 316; by moving one or more of movable units 620, 622, 624; and/or by a combination of movements of build table 316 and movable units 620, 622, 624. Typically, for casting large, unwieldy, and heavy objects, build table 316 may be limited to providing relative motion in the z-direction. In some embodiments, the build table 316 is moved between production layers. In some embodiments, the build table 316 is moved between the construction of the mold region and the production of the object region of the current production layers. In some embodiments, the x-y relative motion may be accomplished by moving units 620, 622, and 624 and not build table 316. In related embodiments, movement of various units relative to a casting-in-progress is done with the assistance of one or more robotic arm(s) 651.

According to an embodiment of the invention, one or two heaters 624 are physically coupled to the movable molten metal depositor 620, and may share a common movement module (not shown). The common movement unit may provide the physically coupled elements 620, 624 with a shared translational movement along the X and Y axes across build table 316 and along the Z-axis to change the working distance of elements 620, 624 above the current production layer. In some embodiments, the working distance of elements 620, 624 above the current production layer is in the range of 2 millimeters to 20 millimeters.

In various embodiments, heaters 624 include, but are not limited to induction heaters, plasma heaters, electric resistance heaters, and torch heaters.

In various embodiments, molten metal depositor 620 includes crucibles, remote molten metal reservoirs, wire or rod stock for melting, powder for melting or combinations thereof.

In various embodiments, mold constructor 622 includes a mold material reservoir and a mold depositor (not shown in FIG. 6). In other embodiments, mold constructor 622 receives mold materials from remote storage. In a further embodiment, mold constructor 622 receives fabricated mold regions and/or mold assemblies from a remote source, assigned with the multiple production layers.

According to embodiments of the invention, mold materials include mold materials in paste form, powder form, granular form, slurry form, and mold materials mixed with binders, releasing agents, activating agents, UV absorbing particles, crosslinking agents, heat-absorbing particles, or other additives to facilitate mold fabrication and use. According to embodiments of the invention, mold materials include, but are not limited to: ceramics (e.g., zirconia, alumina, magnesia, etc.), sand, clay, metallic powders, and any combination thereof.

In some embodiments, system 600 further comprises a mold surface treatment unit including, but not limited to: a milling, grinding, and polishing components for example, for finishing the inner walls of the mold cavities before metal deposition, for semi-hardening or hardening the mold regions prior to metal deposition.

In some embodiments, the mold surface treatment unit is capable of treating the upper surface of the mold region of the current production layer, for example before constructing the mold region of a consecutive production layer.

In some embodiments, system 600 further comprises a layer surface treatment unit including, but not limited to: milling, grinding, and polishing components for example, for leveling or otherwise treating the upper surface of the current production layer before constructing the mold region of the consecutive production layer.

In some embodiments, which can be combined with other embodiments described herein, system 600 may comprise one or more build table heaters, and the controller may be operative for heating and maintaining the build table at a constant table temperature. For example, for the production of gray iron objects, the constant table temperature may be at the range of 500 to 750 degrees centigrade. In some embodiments, build table heating provides heat for concurrent annealing.

In some embodiments, which can be combined with other embodiments described herein, the controller is further operative to heat the build table to a first build table temperature for mold region construction and to a second build table temperature, different from the first build table temperature, for object region production.

In some embodiments, which can be combined with other embodiments described herein, system 600 further comprises a production chamber encompassing (not shown in FIG. 6) at least the movable build table 316. The production chamber may comprise one or more chamber heaters and controller 525 may be operative for heating and maintaining an environment of the build table at a constant chamber temperature. For example, for gray iron, the constant chamber temperature may be at the range of 500 to 750 degrees centigrade. In some embodiments, production chamber heating provides heat for concurrent annealing.

In some embodiments, which can be combined with other embodiments described herein, controller 525 may be further operative to heat the production chamber to a first chamber temperature for mold region construction and to a second chamber temperature, different from the first chamber temperature, for object region production.

System controller 525 is also shown in FIG. 6. System controller 525 may be implemented digitally or via one or more analog control systems. System controller 525 may contain a processor with executable modules for controlling units 624, 620, and 622 and robotic arm 651. Executable modules cover pre-heating 606, post-heating 610, molten metal deposition 608, top annealing 612, mold creation 602, and mold finishing 604, including control of robotic arm 651. Executable code contains algorithms and routines needed to carry out the specific actions of additive metal casting according to the present invention.

System controller 525 also receives sensor and feedback data from various sensors and detectors 640. Sensors 640 may include sensors for temperature, flow rate, position, speed, pressure, cumulative mass. Sensors 640 may include other sensors such as visible-wavelength cameras, weight sensors (e.g., rod weight sensor and/or build table weight sensors), stereometric vision sensors (e.g., for measuring layer thickness), distance sensors and the like. System controller 525 may also receive operator input (not shown), in order to precisely set up and control an additive metal casting process according to the present invention. As shown in FIG. 5, system controller 525 relies on build plan 530, for data, details, and parameters governing the additive casting operation.

For clarity in FIG. 6, units 624, 620, and 622, and robotic arm 651 are shown as single and separate, but the invention is not limited by the types and number of operational units for each type.

For example, in some embodiments, where more than a single molten metal material is used, multiple molten metal depositors are provided. In other embodiments, where more than a single mold material is used, multiple mold constructors are provided.

The total production throughput may be increased by operating more than a single build table, more than one depositor per build table, more than one mold construction unit per build table and the like. In some embodiments, several units of the same type simultaneously operate in different positions relative to build table 316 for handling different areas of the casting-in-progress. Other such configurations are possible, particularly in the case where there are multiple instances of build table 316.

Embodiments of the invention may be employed for the production of several metallic objects concurrently over a single build table and under a common build plan. Embodiments of the invention may be employed for the production of large and very large metallic objects, for example having a width (or length) in the range of 40 cm to 200 cm.

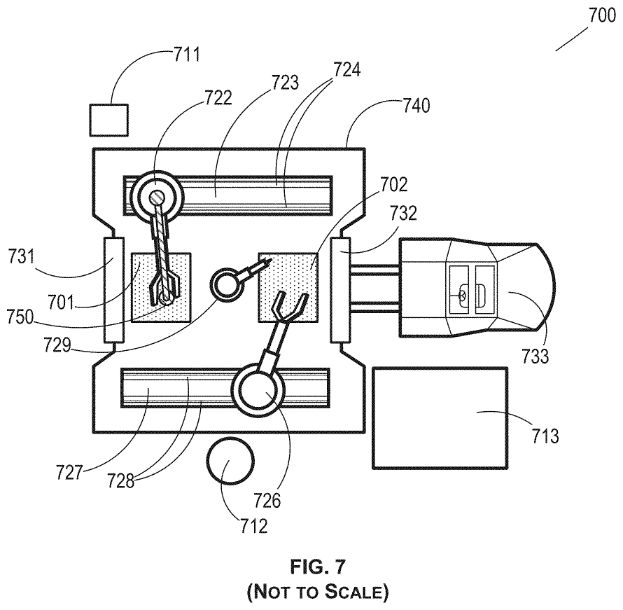

FIG. 7 conceptually illustrates a production floor plan of a contained system 700 for additive metal casting according to various embodiments of the present invention. Goals of these embodiments include enhancing industrial efficiency and safety, improving environmental protection, consolidating production oversight and control, and providing high-throughput and cost effective additive metal casting.

System 700 includes a first build table 701 and a second build table 702, accessible by respective production elements, e.g., as described with reference to FIG. 6. Build tables 701, 702 are capable of operating both in parallel simultaneously, as well as sequentially to optimize performance factors such as throughput, capacity, energy consumption, material utilization, and so on. A first loading/unloading dock 731 and a second loading/unloading dock 732 provide controlled access for introducing and extracting material and finished product.

System 700 includes a containment enclosure 740 which provides an environmental barrier to confine gases, liquids and vapors, and high temperatures in a controlled space. External support facilities include items such as an electrical cabinet 711, a chiller 713, a ceramic feed tank 712, and a lift loader/unloader 733 with external access for ease in maintenance and support. In related embodiments, certain items (such as feed tank 712 and chiller 713) can be located on the roof of containment enclosure 740 to reduce system footprint.

In some embodiments, each of build table 701, 702 may have a length or width in the range of 40 cm to 200 cm. In some embodiments, the footprint of system 700 in framed enclosure 740 is approximately 17 meters×approximately 8.5 meters with a clearance height of approximately 5 meters, for a floor area of approximately 145 square meters and a volume of approximately 720 cubic meters.

Enclosure 740 surrounds hazardous materials, elements, and components of system 700, such as moving components, high-temperatures, and specialized atmospheric environments. In a related embodiment, enclosure 740 is connected to external facility support infrastructures (not shown), including environmental evacuation systems, power mains, water and gas supply, and so forth.

In certain embodiments, system 700 operates in an atmospheric environment. According to other embodiments, the production area is maintained as an inert environment during at least some of the production operations.

In some embodiments, containment enclosure 740 is divided into smaller contained zones, particularly in cases where elevated temperatures are beneficial. In a related embodiment, a build table within enclosure 740 is further enclosed in an oven for keeping a casting-in-progress at an elevated temperature (but below the pre-heating and post-heating temperatures).

In certain embodiments, a first automated production assembly 722 and a second automated production assembly 726 under control of system controller 650 (FIG. 6) provide features of robotic arm 651 and integrate functions of movable units 624, 620, and 622. Automated production assembly 722 is shown combined with an integrated head assembly 750, which provides both heaters 624 and molten metal deposition 620. Automated production assembly 722 is mounted on a linear bed 723 with tracks 724, and automated production assembly 726 is mounted on a linear bed 727 with tracks 728 giving them access to both build table 701 and build table 702.

Also shown in FIG. 7 is a single mold production robotic manipulation assembly 729 for carrying out specialized mold-finishing operations, including, but not limited to mechanical operations such as milling, grinding, and polishing, and operations associated with mold removal.

In some embodiments, which can be combined with other embodiments described herein, there is provided a casting method for additively casting of a metallic object by producing multiple production layers having mold regions and object regions defined by the mold regions, one current production layer after the other up to a top production layer, comprising: constructing a mold region of the current production layer before producing the object region of the current production layer; moving a molten metal depositor over a deposition path and depositing molten metal at a pre-determined deposition temperature in multiple working areas at the object region of the current production layer according to a building plan; and moving one or more heaters over the deposition path and heating the multiple working areas, wherein heating the multiple working areas comprises heating the multiple working areas to a target pre-deposition temperature equal to or above a melting temperature of the metallic object to thereby create a melt pool of molten metal in the working areas before depositing metal on the multiple working areas to affect a bonding of the molten metal with the multiple working areas, wherein each of the working areas is maintained at an inert environment during at least the heating and the depositing, and wherein heating the multiple working areas further comprises providing annealing heating to one or more earlier production layers by heat conduction through the current production layer.

The casting method may further comprise heating the multiple working areas to a post-deposition target temperature after depositing metal on the multiple working areas to affect a thermal cooling profile of the multiple working areas.

Providing annealing heating to the one or more earlier production layers may comprise, after producing the top production layer, providing annealing heating to one or more earlier production layers by heat conduction through the top production layer. Providing annealing heating to one or more earlier production layers by heat conduction through the top production layer may comprise moving one or more heaters over the multiple working areas of the top production layer for one or more successive annealing heating cycles.

The casting method may further comprise changing a height of the one or more heaters above the top production layer after each of the successive annealing heating cycles.

The pre-deposition target temperature may differ from the pre-determined deposition temperature by no more than a predetermined temperature difference.

In some embodiments, which can be combined with other embodiments described herein, there is provided a casting system for additively casting of a metallic object by producing multiple production layers having mold regions and object regions defined by the mold regions, one current production layer after the other on a movable build table up to a top production layer, the system comprising: a movable mold constructor operative to construct a mold region for a current production layer; a movable molten metal depositor operative to deposit molten metal at a pre-determined deposition temperature in multiple working areas at the object region of the current production layer; at least one heater operative for heating the multiple working areas; at least one motion unit coupled to the movable build table, the movable mold constructor, movable molten metal depositor and the one or more heaters; an inert gas unit for maintaining at least the multiple working areas in an inert atmosphere; and a controller operative to iteratively control at least the movable build table, movable mold constructor, movable molten metal depositor, at least one heater, the at least one motion unit and the inert gas unit to produce the metal object according to a predetermined build plan, wherein heating the multiple working areas comprises heating the working areas to a pre-deposition target temperature equal to or above a melting temperature of the metallic object to thereby create a melt pool of molten metal in the working areas before depositing metal on the working areas to affect a bonding of the molten metal with the working areas, wherein each of the working areas is maintained at an inert environment during at least the heating and the depositing, and wherein heating the multiple working areas further comprises providing annealing heating to one or more earlier production layers by heat conduction through the current production layer.

Heating the multiple working areas may further comprise heating the multiple working areas to a post-deposition target temperature after depositing metal on the working areas to affect a thermal cooling profile of the multiple working areas.

The controller may be operative, after producing the top production layer, to providing annealing heating to the one or more earlier production layers by heat conduction through the top production layer. The controller may be operative to moving the one or more heaters over the working areas of the top production layer for two or more successive annealing heating cycles for providing annealing heating to the one or more earlier production layers by heat conduction through the top production layer. The controller may be operative to changing a height of the one or more heaters above the top production layer after each of the successive annealing heating cycles. The controller may be further operative to maintain a difference between the deposition temperature and the pre-deposition temperature to be smaller than a predetermined temperature difference.

The casting system may further comprise a working area temperature sensor communicatively connected to the controller. The working area temperature sensor may be a pyrometer or a thermal camera.

The mold region may have a height for the current production layer according to the build plan, in a range of 2 millimeters to 12 millimeters. The movable mold constructor may comprise a mold material reservoir and a mold material dispensing assembly in connection therewith, for additively dispensing a mold material in predefined locations to form the mold region in the current production layer according to the build plan. The movable mold constructor may include a plurality of remotely-produced mold structures and comprises a mold transfer unit operative to transfer a remotely-produced mold structure to a predefined location to form the mold region in the current production layer according to the build plan.

The casting system may further comprise a production chamber encompassing at least the movable build table and comprising one or more chamber heaters, and wherein the controller is further operative to heat the production chamber to a first chamber temperature for mold region construction and to a second chamber temperature, different from the first chamber temperature, for object region production.

The casting system may further comprise one or more build table heaters, and wherein the controller is further operative to heat the build table to a first build table temperature. The controller may be further operative to heat the build table to a first build table temperature for mold region construction and to a second build table temperature, different from the first build table temperature, for object region production.

Embodiments of the invention were described with respect to the additive casting of gray iron. The invention is not limited by the type of cast material. The invention is applicable for the additive casting of other metals, including ductile iron, steel, and other metals, with the appropriate modifications.

Aspects of the invention were described with respect to the melt pool embodiments; the invention is applicable for the overheating embodiments, with the appropriate modifications.

Unless specifically stated otherwise, as apparent from the preceding discussions, it is appreciated that, throughout the specification, discussions utilizing terms such as “processing,” “computing,” “calculating,” “determining,” or the like refer to the action and/or processes of a general-purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

Embodiments of the invention may include apparatus for performing the operations herein. This apparatus may be specially constructed for the desired purposes, or it may comprise a computing device or system typically having at least one processor and at least one memory, selectively activated or reconfigured by a computer program stored in the computer. The resultant apparatus, when instructed by software, may turn the general-purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMS), electrically programmable read-only memories (EPROMs), electrically erasable and programmable read-only memories (EEPROMs), magnetic or optical cards, Flash memory, disk-on-key or any other type of media suitable for storing electronic instructions and capable of being coupled to a computer system bus. The computer readable storage medium may also be implemented in cloud storage.

Some general-purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

### APPENDIX—METALLURGICAL EVALUATION

FIG. 8a through FIG. 8f depict results of a metallurgical evaluation conducted on coupons of cast objects produced according to an embodiment of the invention.

Three cast metal objects were produced for the evaluation—respectively labeled 1, 2, and 3. The three cast metal objects were cut as vertical slices from a cast cube of metal 15 cm on each edge. Casting the cube was carried out in an atmosphere with controlled oxygen content. The base layer was a 15 cm×15 cm square of sintered alumina ceramic 0.5 cm thick. Metal was additively deposited in a stack of sequential layers inside a mold cavity formed by a 15 cm×15 cm hollow square frame mold of sintered alumina ceramic. Deposition and heating were performed by a movable heating and deposition unit in a raster scan pattern.

FIG. 8a is a photograph of slice 2. This side was originally an outside face of the cast cube (the x-z plane), and this surface was not given any finishing treatments—the faint horizontal lines visible in FIG. 8a, for example, are impressions made by the mold.

FIG. 8b is a photograph showing the back side of slice 2. This was the inner side of slice 2, and it was polished after being sliced from the cube. FIG. 8c is a photographic perspective view of slice 2. The smoothness of the polished face is visible in this view.

Objects 1 and 3 were cut into metal coupons: horizontal bottom coupons (left, center, right); horizontal top coupons (left, center, right), and vertical coupons (left, center, right). The coupons have a gauge length of 32 millimeters, total length between 65-70 millimeters, thickness in the range 1.8-2.45 millimeters, and width in the range of 4.9-5.5 millimeters.

Elemental analysis, mechanical, and strength testing of 18 coupons from the cast labeled 1, and 17 coupons from the cast labeled 3 were conducted.

Elemental analysis was performed with XRF spectroscopy. Only principal alloying components were analyzed to validate the difference or similarity of the different coupons in a cast and between casts 1 and 3. The table in FIG. 8d depicts the elemental analysis of representative coupons. The elemental analysis validated the similarity between upper and bottom coupons, left, middle and right coupons, and cast 1 and 3 coupons.

Mechanical and strength testing was performed on a Servo hydraulic tension testing machine MTS 370.10. The strain rate applied was 0.14 min-1. An extensometer of base length 25 millimeters was used to measure strain data and remained attached on the coupons until fracture.

FIG. 8e and FIG. 8f are stress-strain charts for all the coupons. The stress-strain charts have a similar appearance, typical for cast iron. The mechanical strength testing validated the similarity between upper and bottom coupons, left, middle and right coupons, and cast 1 and 3 coupons.

Overall, no significant difference between analyzed parts 1 and 3 was revealed, showing a high level of uniformity in the mechanical properties of the cast parts.

1. A casting method for additively casting of a metallic object in a production chamber encompassing at least a build table by producing multiple production layers having mold regions and object regions defined by the mold regions, one current production layer after the other up to a top production layer, comprising:
constructing a mold region of the current production layer before producing the object region of the current production layer;
moving a molten metal depositor over a deposition path and depositing molten metal at a predetermined deposition temperature in multiple working areas at the object region of the current production layer according to a building plan; and
moving one or more heaters over the deposition path and heating the multiple working areas,
wherein heating the multiple working areas comprises at least one of: (1) heating the multiple working areas to a pre-deposition target temperature before depositing metal on the multiple working areas to affect a bonding of the molten metal with the multiple working areas, and (2) heating the multiple working areas to a post-deposition target temperature after depositing metal on the multiple working areas to affect a thermal cooling profile of the multiple working areas,
wherein heating the multiple working areas further comprises providing annealing heating to one or more earlier production layers by heat conduction through the current production layer, and
wherein heating the multiple working areas further comprises controlling a temperature of the production chamber at one or more predetermined values.

2. The casting method of claim 1 wherein providing annealing heating to the one or more earlier production layers comprises, after producing the top production layer, providing annealing heating to one or more earlier production layers by heat conduction through the top production layer.

3. The casting method of claim 2 wherein providing annealing heating to one or more earlier production layers by heat conduction through the top production layer comprises moving the one or more heaters over the multiple working areas of the top production layer for one or more successive annealing heating cycles.

4. The casting method of claim 3 further comprising changing a height of the one or more heaters above the top production layer after each of the successive annealing heating cycles.

5. The casting method of claim 1 wherein the pre-deposition target temperature is equal to or above a melting temperature of the metallic object.

6. The casting method of claim 1 wherein the pre-deposition target temperature differs from the predetermined deposition temperature by no more than a predetermined temperature difference.

7. The casting method of claim 1 wherein, in each current production layer above a base layer, the mold region constitutes, with the earlier production layer, at least one cavity and wherein the molten metal is deposited within the cavity.

8.-20. (canceled)

21. The casting method of claim 1 wherein the chamber heater is used to heat the production chamber to a first temperature during construction of the mold region and to heat the production chamber to a second temperature during deposition of the molten metal, wherein the first temperature is different from the second temperature.

22. The casting method of claim 21 wherein the first temperature is less than the second temperature.

23. The casting method of claim 1 wherein heating the multiple working areas further comprises heating the production chamber to a chamber temperature using a chamber heater separate from the one or more heaters.

24. The casting method of claim 2 wherein providing annealing heating to one or more earlier production layers by heat conduction through the top production layer comprises:
moving the one or more heaters over the multiple working areas of the top production layer for two or more successive annealing heating cycles; and
increasing a height of the one or more heaters above the top production layer after each of the successive annealing heating cycles.
